(19) United States
(12) Patent Application Publication
(10) Pub. No.: US 2012/0187780 A1
(43) Pub. Date: Jul. 26, 2012

(54) APPARATUS FOR GENERATING VIBRATIONS

(75) Inventors: Je Hyun BANG, Suwon (KR); Suck Jun Park, Suwon (KR); Jun Kun Choi, Suwon (KR); Yong Jin Kim, Suwon (KR)

(73) Assignee: SAMSUNG ELECTRO-MECHANICS CO., LTD.

(21) Appl. No.: 13/168,470

(22) Filed: Jun. 24, 2011

(30) Foreign Application Priority Data
Jan. 25, 2011 (KR) 10-2011-0007272

(51) Int. Cl. H02K 33/00

(52) U.S. Cl. 310/25

(57) ABSTRACT

There is provided an apparatus for generating vibrations, the apparatus including: a lower case made of a non-magnetic material; a coil plate mounted on the lower case and made of a magnetic material so as to reduce magnetic force leakage; a coil mounted on the coil plate; and a motion element including a magnet disposed to be opposite to the coil such that an electromagnetic force is generated by interaction with the coil.

### CROSS-REFERENCE TO RELATED APPLICATIONS

This application claims the priority of Korean Patent Application No. 10-2011-0007272 filed on Jan. 25, 2011, in the Korean Intellectual Property Office, the disclosure of which is incorporated herein by reference.

### BACKGROUND OF THE INVENTION

1. Field of the Invention

The present invention relates to an apparatus for generating vibrations, and more particularly, to an apparatus for generating vibrations through electromagnetic force.

2. Description of the Related Art

A vibration motor, a component converting electrical energy into mechanical vibrations using the principle of generating an electromagnetic force, is mounted in a mobile phone to be used for silently notifying a user of call reception by transferring vibrations thereto.

In accordance with the rapid growth in the market for mobile phones and the trend of multi-functionality in mobile phone, mobile phone components having a compact size and a high quality have been required. In this situation, the demand for the development of a vibration motor having a new structure in which the disadvantages of an existing vibration motor are improved and quality is significantly improved has increased.

In recent years, as the release of mobile phones having a large liquid crystal display (LCD) screen has rapidly increased, a touch screen scheme has been adopted, such that a vibration motor has been used in order to generate vibrations when a user touches the LCD screen.

As the vibration motor has come to be used more frequently, as compared to a case in which vibrations are generated only at the time of call reception, an increase in the operational lifespan thereof has been required. Also, a vibration response speed should be increased according to a speed at which the screen is touched so that a user may experience a high level of satisfaction in feeling vibrations when touching the LCD screen.

However, in a vibration motor according to the related art, mechanical friction and electrical sparks may occur during the rotation of a rotating part having an unbalanced mass. Therefore, abrasion has been generated, and foreign materials have also been generated at the time of spark generation, thereby reducing the lifespan of the motor.

The vibration motor according to the related art generates vibrations through the inertia of the rotating part having the unbalanced mass. Therefore, it has taken a long time to arrive at target vibrating amount, such that a response speed is slow.

In order to prevent this problem, a linear type vibration motor has been used.

However, in the linear type vibration motor, an attractive force may be generated between a magnet and a case due to a magnetic force generated from the magnet for generating vibrations by electromagnetic interaction with a coil, thereby reducing vibratory strength.

### SUMMARY OF THE INVENTION

An aspect of the present invention provides an apparatus for generating vibrations including a case made of a non-magnetic material.

According to an aspect of the present invention, there is provided an apparatus for generating vibrations, the apparatus including: a lower case made of a non-magnetic material; a coil plate mounted on the lower case and made of a magnetic material so as to reduce magnetic force leakage; a coil mounted on the coil plate; and a motion element including a magnet disposed to be opposite to the coil, such that an electromagnetic force is generated by interaction with the coil.

The motion element may further include a mass body having a mounting hole formed at a center part thereof and an elastic member mounted around the mass body to provide an elastic force thereto.

The apparatus may further include an upper case combined with the lower case to form an internal space together with the lower case.

The lower case may include a circuit board mounted on a bottom thereof, the circuit board having the coil plate mounted thereon, and the coil plate may penetrate through a through hole formed in the lowercase to be mounted on the circuit board.

The motion element may be vibrated in a direction parallel to the circuit board.

The magnet may be mounted in a mass body so as to be inserted into a mounting hole of the mass body.

The elastic member may be formed of a leaf spring supporting at least two sides of the mass body to provide the elastic force thereto.

The elastic member may include first and second elastic members supporting both sides of the mass body, and each of the first and second elastic members may include a plate part fixedly mounted on the side of the mass body, an elastic deformation part formed to be extended from the plate part and bent, and a fixing mounting part formed at an end of the elastic deformation part.

A magnetic fluid may be applied to at least one of the magnet and the coil.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view showing an apparatus for generating vibrations according to an exemplary embodiment of the present invention;

FIG. 2 is an exploded perspective view showing an apparatus for generating vibrations according to an exemplary embodiment of the present invention; and

FIGS. 3 and 4 are views describing the operation of an apparatus for generating vibrations according to an exemplary embodiment of the present invention.

### DETAILED DESCRIPTION OF THE PREFERRED EMBODIMENT

Exemplary embodiments of the present invention will now be described in detail with reference to the accompanying drawings.

However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, detailed descriptions related to well-known functions or configurations will be ruled out in order not to unnecessarily obscure subject matters of the present invention.

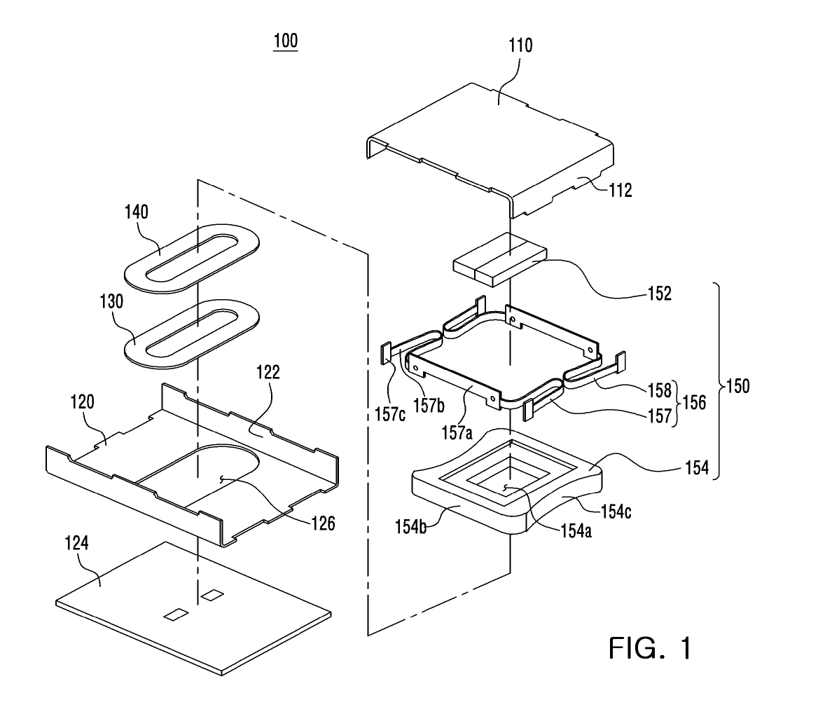

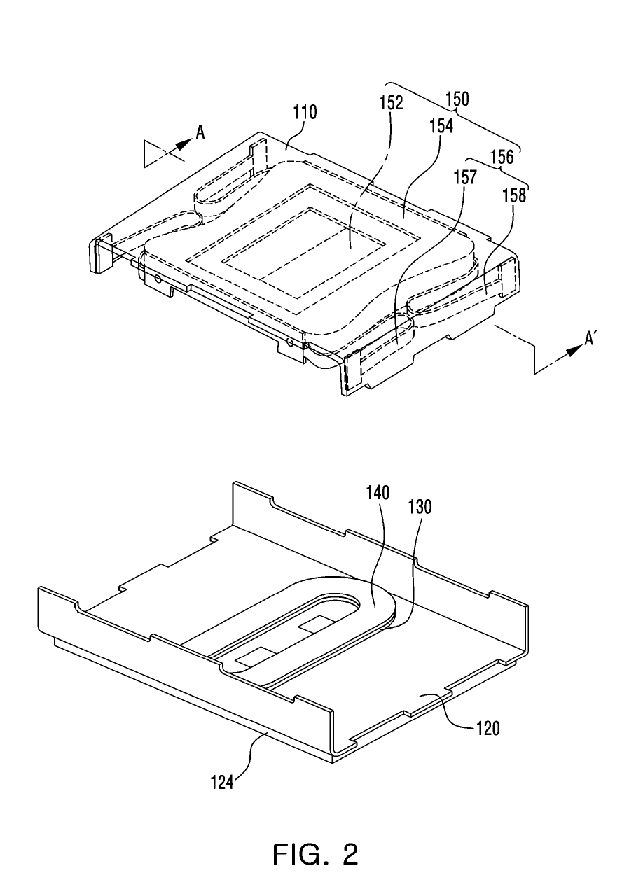

FIG. 1 is a first exploded perspective view showing an apparatus for generating vibrations according to an exemplary embodiment of the present invention; and FIG. 2 is a second exploded perspective view showing an apparatus for generating vibrations according to an exemplary embodiment of the present invention.

Referring to FIGS. 1 and 2, an apparatus 100 for generating vibrations may be configured to include an upper case 110, a lower case 120, a coil plate 130, a coil 140, and a motion element 150.

The upper case 110 is combined with the lower case 120 to form an internal space. Meanwhile, the upper case 110 may be provided with an upper bent part 112 forming a sidewall closing the internal space when it is combined with the lower case 120.

The lower case 120 may be made of a non-magnetic material. The lower case 120 is combined with the upper case 110 to form the internal space having the motion element 150 mounted and moved therein, as described above.

Meanwhile, the lower case 120 may include a lower bent part 122 formed to be extended upwardly so as not to interfere with the upper bent part 112 of the upper case 110. That is, the upper bent part 112 and the lower bent part 122 form the sidewall enclosing the internal space when the upper case 110 is combined with the lower case 120.

In addition, the lower case 120 may include a circuit board 124 mounted on a bottom thereof. Although the present exemplary embodiment describes a case in which the circuit board 124 is mounted on the bottom of the lower case 120, the present invention is not limited thereto. That is, the circuit board 124 may be mounted on an upper surface of the lower case 120 to be disposed in the internal space formed by the upper case 110 and the lower case 120.

In addition, the lower case 120 may include a through hole 126 penetrating therethrough, such that the coil plate 130 may be mounted on the circuit board 124. The through hole 126 may have a shape corresponding to those of the coil plate 130 and the coil 140, and may be disposed at a center part of the lower case 120.

The coil plate 130 is mounted on the lower case 120 and is made of a magnetic material so as to reduce magnetic force leakage. More specifically, the coil plate 130 may be mounted on the circuit board 124 mounted on the bottom of the lower case 120. In this configuration, the coil plate 130 may be disposed in the through hole 126 of the lower case 120.

In addition, the coil plate 130 may be made of the magnetic material. Therefore, the leakage of the magnetic force may be reduced even if the lower case 120 is made of the non-magnetic material.

For example, the coil plate 130 may have an oval ring shape.

Meanwhile, the coil 140 may be disposed above or on the coil plate 130. That is, the coil 140 may be mounted in the lower case 120 so as to be disposed above the coil plate or may be mounted on the coil plate 130.

In addition, the coil 140 is connected to the circuit board 124, and forms an electric field by a supplied current. The motion element 150 may be vibrated through the electric field formed by the coil 140.

Further, the coil 140 may have a shape corresponding to that of the coil plate 130 by way of example.

The motion element 150 includes a magnet 152 disposed to be opposite to the coil 140 such that an electromagnetic force is generated by interaction with the coil 140. In addition, the motion element 150 may further include a mass body 154 and an elastic member 156.

Meanwhile, the magnet 152 allows the motion element 150 to be vibrated due to electromagnetic force through interaction with the coil 140.

A magnetic fluid may be applied to the magnet 152 and the coil 140.

In addition, the motion element 150 may be vibrated in a direction parallel to the circuit board 124.

A center part of the mass body 154 is provided with a mounting hole 154a in which the magnet 152 is fixedly mounted. In addition, the mounting hole 154a has a shape corresponding to that of the magnet 152, and the magnet 152 and the mass body 154 are vibrated together by the electromagnetic force.

In addition, although the present exemplary embodiment describes a case in which the magnet 152 and the mounting hole 154a have a rectangular shape by way of example, the shapes of the magnet 152 and the mounting hole 154a are not limited thereto. That is, the magnet 152 and the mounting hole 154a may have various shapes such as a cylindrical shape, a cubic shape, and the like.

Meanwhile, the mass body 154 has a hexahedral shape, two opposite sides of four sides of the mass body 154 may be formed as a flat surface 154b having the elastic member 156 mounted thereon, and other two sides thereof may be formed to have an inclined surface 154c with a center part formed to be depressed, such that an elastic force may be provided by the elastic member 156.

In addition, the mass body 154 may be made of a tungsten material.

The elastic member 156 is mounted around the mass body 154 to provide elastic force thereto. Further, the elastic member 156 may be formed of a leaf spring mounted on at least two sides of the mass body 154 to provide elastic force thereto.

More specifically, the elastic member 156 is configured of first and second elastic members 157 and 158 by way of example.

The first and second elastic members 157 and 158 have the same shape and are disposed to be opposite to each other. Therefore, hereinafter, only the first elastic member 157 will be described, and a detailed description of the second elastic member 158 will be omitted.

The first elastic member 157 includes a plate part 157a mounted on the flat surface 154b of the mass body 154. That is, the plate part 157a of the first elastic member 157 is fixedly mounted on the flat surface 154b of the mass body 154, whereby the elastic force may be stably provided to the mass body 154 at the time of the movement of the mass body 154.

In addition, the first elastic member 157 may include elastic deformation parts 157b formed to be extended from the plate part 157a and bent to a side on which the inclined surface 154c of the mass body 154 is formed.

The elastic deformation part 157b has a ‘U’ shape, such that as the mass body 154 moves, the elastic deformation part 157b having the ‘U’ shape is deformed to provide elastic force to the mass body 154.

In addition, an end of the elastic deformation part 157b may be provided with a fixing mounting part 157c fixedly mounted on any one of the upper case 110 and the lower case 120.

That is, the fixing mounting parts 157c formed at both ends of the first elastic member 157 are fixedly mounted on the upper case 110 by way of example, and the plate part 157a of the first elastic member 157 is fixedly mounted on the flat surface 154b of the mass body 154.

Therefore, when the mass body 154 moves, the elastic force is provided to the mass body 154, while the elastic deformation parts 157b on both sides of the first elastic member 157 are alternately pressed. That is, the mass body 154 is reciprocally moved toward the elastic deformation parts 157b on the both sides of the first elastic member 157, thereby generating vibrations.

As described above, even in the case that the lower case 120 is made of a non-magnetic material, the attractive force between the magnet 152 and the lower case 120 may be reduced, while a reduction in the electromagnetic force may be minimized through the coil plate 130 made of a magnetic material, whereby the amount of vibrations may be increased.

Hereinafter, an effect of the present invention will be described in detail with reference to the accompanying drawings.

First, the lower case 120 included in the apparatus 100 for generating vibrations according to the exemplary embodiment of the present invention is made of a non-magnetic material. Further, the coil plate 130 is mounted on the circuit board 124 mounted on the lower case 120. In addition, the coil plate 130 is made of a magnetic material.

Meanwhile, the magnet 152 included in the motion element 150 is mounted in the mass body 154 to be disposed to be opposite to the coil plate 130.

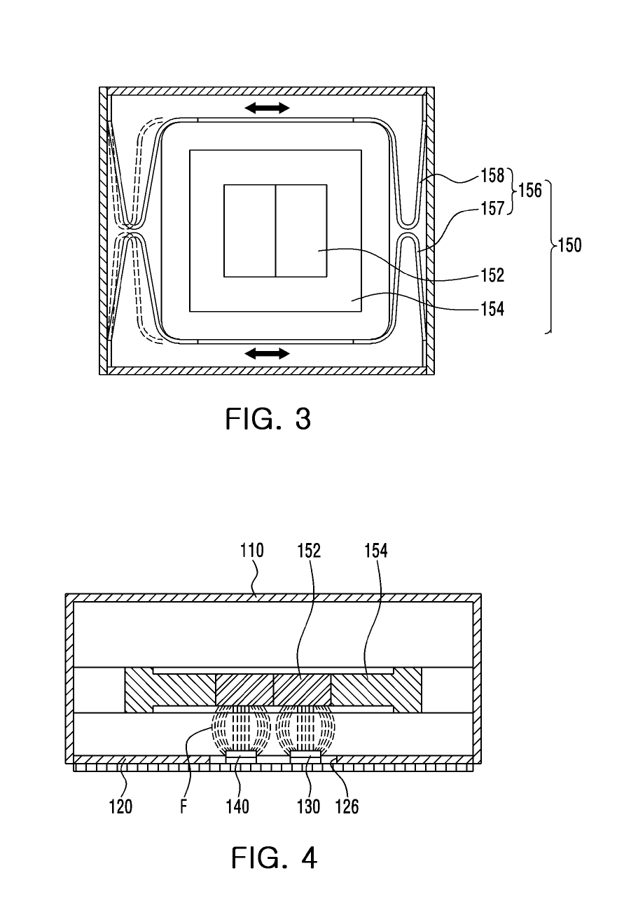

In addition, when current is applied to the coil 140, the mass body 154 having the magnet 152 mounted therein starts to be vibrated in the horizontal direction as shown in FIG. 3 by electromagnetic interaction between the coil 140 and the magnet 152.

At this time, the elastic member 156 provided to both sides of the mass body 154 is elastically deformed, whereby the mass body 154 may be vibrated.

Meanwhile, as shown in FIG. 4, the attractive force is not generated between the lower case 120 made of the non-magnetic material and the magnet 152. In addition, the coil plate 130 serves to enlarge a magnetic force F by which the magnet 152 is linked to the coil 140, whereby the electromagnetic force may be increased without a significant increase in the volume thereof.

In other words, the attractive force generated between the lower case 120 and the magnet 152 may be removed, as compared to the case in which the lower case 120 is made of the magnetic material, such that the amount of vibrations may be increased.

In addition, although the lower case 120 is made of the non-magnetic material, the leakage of the magnetic force at which the magnet 152 is linked to the coil 140 may be reduced by the coil plate 130, such that a reduction in the amount of vibrations may be minimized.

According to the exemplary embodiments of the present invention, as the lower case may be made of the non-magnetic material, the attractive force between the magnet and the lower case may be reduced, while a reduction in the electromagnetic force may be minimized through the coil plate made of the magnetic material, whereby the amount of vibrations may be increased.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for generating vibrations, the apparatus comprising:
a lower case made of a non-magnetic material;
a coil plate mounted on the lower case and made of a magnetic material so as to reduce magnetic force leakage;
a coil mounted on the coil plate; and
a motion element including a magnet disposed to be opposite to the coil such that an electromagnetic force is generated by interaction with the coil.

2. The apparatus of claim 1, wherein the motion element further includes a mass body having a mounting hole formed at a center part thereof and an elastic member mounted around the mass body to provide an elastic force thereto.

3. The apparatus of claim 2, further comprising an upper case combined with the lower case to form an internal space together with the lower case.

4. The apparatus of claim 1, wherein the lower case includes a circuit board mounted on a bottom thereof, the circuit board having the coil plate mounted thereon, and
the coil plate penetrates through a through hole formed in the lower case to be mounted on the circuit board.

5. The apparatus of claim 4, wherein the motion element is vibrated in a direction parallel to the circuit board.

6. The apparatus of claim 4, wherein the magnet is mounted in a mass body so as to be inserted into amounting hole of the mass body.

7. The apparatus of claim 2, wherein the elastic member is formed of a leaf spring supporting at least two sides of the mass body to provide the elastic force thereto.

8. The apparatus of claim 7, wherein the elastic member includes first and second elastic members supporting both sides of the mass body, and
each of the first and second elastic members includes a plate part fixedly mounted on the side of the mass body, an elastic deformation part formed to be extended from the plate part and bent, and a fixing mounting part formed at an end of the elastic deformation part.

9. The apparatus of claim 1, wherein a magnetic fluid is applied to at least one of the magnet and the coil.

10. An apparatus for generating vibrations, the apparatus comprising:
a lower case made of a non-magnetic material;
an upper case combined with the lower case to form an internal space therebetween;
a coil plate mounted on the lower case and made of a magnetic material so as to reduce magnetic force leakage;
a coil disposed on the coil plate; and
a motion element including a magnet disposed to be opposite to the coil such that an electromagnetic force is generated by interaction with the coil, a mass body having the magnet mounted at a center part thereof, an elastic member supporting at least two sides of the mass body to provide an elastic force thereto.
